(19) United States
(12) Patent Application Publication
(10) Pub. No.: US 2026/0102934 A1
(43) Pub. Date: Apr. 16, 2026

(54) PERSONAL CARE SYSTEM AND DEVICE

(71) Applicant: KONINKLIJKE PHILIPS N.V., EINDHOVEN (NL)

(72) Inventors: MAURITS KOENEN, DRACHTEN (NL); LUIGI BALESTRINI, ZUIDHORN (NL)

(21) Appl. No.: 19/114,959

(22) PCT Filed: Sep. 20, 2023
(86) PCT No.: PCT/EP2023/075930

§ 371 Date: Mar. 25, 2025

(30) Foreign Application Priority Data
Sep. 28, 2022 (EP) 22198370.3

(51) Int. Cl. B26B 19/38; A45D 27/46

(52) U.S. Cl. CPC B26B 19/3833; A45D 27/46

(57) ABSTRACT

A personal care system comprises a personal care device and a cleaning device. The personal care device has a motion sensor, and the cleaning device has a supporting structure for supporting the personal care device in a cleaning position for cleaning the personal care unit, and it used a cleaning device motor. The cleaning device implements a cleaning device cleaning program in response to a user action, and the personal care device implements a corresponding personal care device cleaning program in response to detection of the cleaning device cleaning program from the motion sensor signals.

### FIELD OF THE INVENTION

The present invention relates to a personal care system comprising a personal care device (such as a shaver) and a cleaning device for the personal care device. The invention further relates to a personal care device for use in such a system and a cleaning method.

### BACKGROUND OF THE INVENTION

There are various personal care devices which need periodic cleaning both for hygiene reasons and to maintain the device function. For example, hair cutting or removal devices can become clogged with hair, skin grease or applied cosmetics. To simplify the cleaning process for the user, there are systems which combine a personal care device and a cleaning device.

For example, WO 2004/086901 discloses a shaving system comprising a shaver and a cleaning device. The shaver comprises a main housing and a shaving unit coupled to the main housing, wherein the main housing accommodates an electric motor for driving the shaving unit. The cleaning device comprises a supporting structure for supporting the shaver, and a receiving space for receiving the shaving unit when the shaver is arranged in a cleaning position supported by the supporting structure.

The cleaning device comprises a reservoir for containing a cleaning fluid and a pump for transporting the cleaning liquid from the reservoir to the receiving space.

In the known shaving system, the shaver can be supported upside down within a support of the cleaning device that can be manually moved downwardly so that the shaving unit enters into a reservoir into which the cleaning fluid from the reservoir can be pumped using an external manually operated pumping system. The cleaning function for example involves a particular sequence of pump operations, to implement a cleaning cycle, and also a sequence of operations of the shaver.

The cleaning maintenance provided by such a shaving system is advantageous for keeping a correctly functioning and hygienic shaver.

The utilization of a dedicated cleaning device according to WO 2004/086901 is not convenient for the user, because the pumping unit of the cleaning device must be driven manually.

EP 3 771 528 A1 discloses a personal care system comprising a shaving device and a cleaning device for the shaving unit of the shaving device. The shaving device has an orientation sensor for generating an output signal representing the orientation of the shaving device. The cleaning device supports the shaving device in a cleaning position with a predefined cleaning orientation. The cleaning device is controlled to operate according to a predefined cleaning program for cleaning the shaving unit when the orientation of the shaving device sensed by the orientation sensor corresponds to said predefined cleaning orientation. This known personal care system thus makes use of an orientation sensor to identify when the shaving device is in the cleaning position within the cleaning device. In an embodiment, a mechanical drive coupling is provided between the shaving device and the cleaning device to enable the motor of the shaving device to drive a pump of the cleaning device when the shaving device is placed in the cleaning device. This may allow the cleaning device to be entirely mechanical, thereby reducing the overall costs of the cleaning device, while maintaining ease of use for the user. However, this complicates the interface between the shaving device and the cleaning device.

There remains a need for a simple to use cleaning system with low complexity and hence low cost.

### SUMMARY OF THE INVENTION

The invention is defined by the claims.

According to examples in accordance with an aspect of the invention, there is provided a personal care system comprising a personal care device and a cleaning device, wherein:
the personal care device comprises:
   a care device motor;
   a personal care unit driven by the care device motor;
   a motion sensor; and
   a care device controller; and
the cleaning device comprises:
   a supporting structure for supporting the personal care device in a cleaning position for cleaning the personal care unit;
   a cleaning unit; and
   a cleaning device controller, wherein:
there is no electrical communication and no mechanical drive coupling between the personal care device and the cleaning device,
the cleaning device controller is configured to implement a cleaning device cleaning program in response to a user action; and
the care device controller is configured to implement a corresponding personal care device cleaning program in response to detection of the cleaning device cleaning program from the motion sensor signals.

This system implements a cleaning program in the cleaning device and the personal care device when a user instructs the start of the cleaning program, by actuating the cleaning device.

This actuation (the user action) may for example involve pressing a button on the cleaning device, but it may simply involve placing the personal care device suitably on the supporting structure.

To simplify the communication required between the cleaning device and the personal care device in order to coordinate and synchronize their respective cleaning programs, the personal care device detects motion imparted to the personal care device by the cleaning program, e.g. vibrations of a sound generating cleaning unit such as an ultrasonic cleaning unit. This avoids the need for electrical communication between the cleaning device and the personal care device, or a mechanical drive coupling. More generally, it avoids the need for any form of signal generation dedicated to communication between the personal care device and the cleaning device e.g., electrical or optical, as well as avoiding the need for a complex mechanical interface between the cleaning device and the personal care device. The cleaning device and the personal care device effectively remain independent, with the personal care device sensing the cleaning operation of the cleaning device using motion sensing.

The mounting of the personal care device to the supporting structure for example provides a clamping in such a way that vibrations caused by the cleaning device cleaning program are transferred to the personal care device itself.

The personal care device can also optionally sense its position, for example because a cleaning program is only appropriate when the personal care device is upside down.

The system avoids the need for the user to perform any activation of the personal care device itself to implement synchronized cleaning programs in both the cleaning device and the personal care device.

The system can have a universal cleaning device for different personal care devices, because the need for a special interface between the personal care device and the cleaning device is avoided. Another advantage is that the cleaning program of the personal care device cannot be started by mistake by the user while handling the device. This can only happen in a controlled way, via a well-defined vibration pattern which has to be detected.

The motion sensor for example comprises an accelerometer. It may be used to detect orientation as well as vibration, or a separate sensor may be used for detecting orientation.

The cleaning unit for example comprises a sound generating unit. This generates characteristic vibrations which can be transferred from the cleaning device to the personal care device.

The cleaning unit for example comprises an ultrasonic vibration generator, wherein the care device controller is configured to detect and recognize ultrasonic vibration generator vibrations.

The cleaning device cleaning program may comprise a sequence of vibration phases and waiting phases. The vibration phases perform cleaning, and the waiting phases allow adjustments to be made to the personal care device.

For example, the personal care device cleaning program may comprise rotations of the personal care unit between the vibration phases so that different parts of the personal care unit are subjected to the ultrasonic cleaning.

There may be stationary holding of the personal care unit during the vibration phases.

The personal care system for example comprises a hair treatment system, the personal care device comprises a hair treatment device and the personal care unit comprises a hair treatment unit.

The hair treatment device may comprise a shaver or trimmer and the hair treatment unit comprises a shaver or trimmer head, or the hair treatment device may comprise an epilator and the hair treatment unit comprises an epilator head.

The invention also provides a personal care device comprising:
a motor;
a personal care unit driven by the motor;
a motion sensor; and
a care device controller,
wherein the care device controller is configured to implement a personal care device cleaning program in response to detection of the start of a cleaning program of a remote cleaning device which supports the personal care device in a cleaning position for cleaning the personal care unit, and
wherein the personal care device cleaning program is started based on motion sensor signals with no electrical communication and no mechanical drive coupling between the personal care device and the cleaning device.

This defines the personal care device, which activates a cleaning program by recognizing characteristic vibrations of a coupled cleaning device.

The motion sensor for example comprises an accelerometer.

As explained above, the personal care device may comprise a hair treatment device and the personal care unit comprises a hair treatment unit, and the hair treatment device may comprises a shaver or trimmer and the hair treatment unit comprises a shaver or trimmer head, or the hair treatment device may comprise an epilator and the hair treatment unit comprises an epilator head.

The invention also provides a method of controlling a personal care system comprising a personal care device and a cleaning device, the method comprising:
implementing a cleaning device cleaning program in response to a user action, thereby to drive a cleaning unit of the cleaning device; and
detecting motion of the personal care device resulting from movements generated by the cleaning device cleaning program, using a motion sensor of the personal care device, and in response implementing a corresponding personal care device cleaning program,
such that the personal care device cleaning program is implemented with no electrical communication and no mechanical drive coupling between the personal care device and the cleaning device.

The invention also provides a computer program comprising computer program code means which is adapted, when said program is run on the controllers of a cleaning device and personal care device of a persona care system, to implement the method above.

The invention also provides a method of controlling a personal care device comprising a motor, a personal care unit driven by the motor and a motion sensor, wherein the method comprises:
detecting motion of the personal care device resulting from movements generated by a cleaning device cleaning program of a remote cleaning device which supports the personal care device in a cleaning position for cleaning the personal care unit, using the motion sensor of the personal care device, and in response implementing a corresponding personal care device cleaning program,
such that the personal care device cleaning program is implemented with no electrical communication and no mechanical drive coupling between the personal care device and the cleaning device.

The invention also provides a computer program comprising computer program code means which is adapted, when said program is run on the controller of a personal care device of a personal care system, to implement the method above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a perspective view of a shaving system according to the invention, wherein a shaver with an orientation sensor is placed on a support structure of a respective cleaning device;

FIG. 2 shows an enlarged perspective view of the cleaning device of the shaving system of FIG. 1 without the shaver; and

FIG. 3 shows an example of synchronized cleaning programs between a shaver and cleaning device.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides a personal care system which comprises a personal care device and a cleaning device. The personal care device has a motion sensor, and the cleaning device has a supporting structure for supporting the personal care device in a cleaning position for cleaning the personal care unit, and it used a cleaning device motor. The cleaning device implements a cleaning device cleaning program in response to a user action, and the personal care device implements a corresponding personal care device cleaning program in response to detection of the cleaning device cleaning program from the motion sensor signals. The invention also provides the personal care device of the system.

The invention may be applied to any electric hand held personal care device which may benefit from cleaning by an external cleaning device.

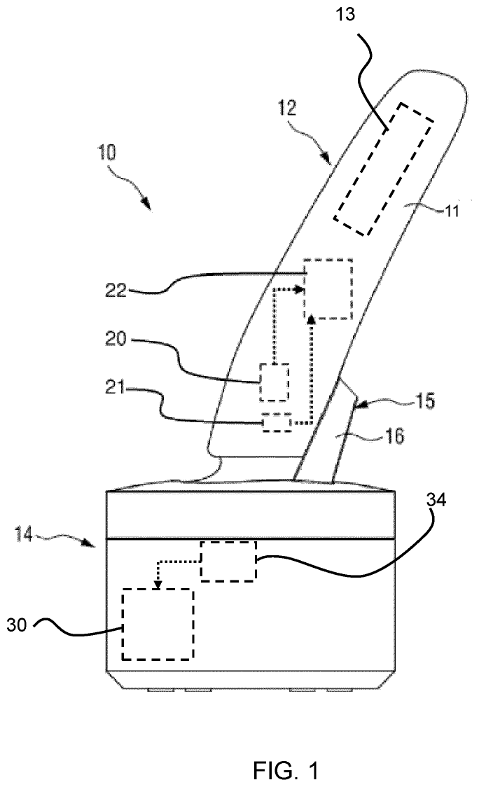

By way of example, FIG. 1 shows a personal care system in the form of a shaving system 10. The shaving system 10 comprises a shaver 12 (i.e. an example of personal care device) having a main housing 11 and a cleaning device 14 including a supporting structure 15. The shaver 12 can be placed on the cleaning device in a cleaning position. In the cleaning position, the shaver 12 has a predefined cleaning orientation. As shown, the cleaning orientation is essentially vertical with the shaving unit facing downwardly. The cleaning device 14 comprises a pot-shaped housing and a rest 16 protrudes from the top of the housing. The rest 16 serves to support a main housing of the shaver 12 when the shaver 12 is placed on the supporting structure 15 as shown in FIG. 1.

The shaver has a motor 13 and a shaving head (i.e. an example of a personal care unit) driven by the motor. FIG. 1 further schematically shows a motion sensor 21 and an optional orientation sensor 20 provided in the main housing of the shaver 12. The optional orientation sensing may be performed by the motion sensor itself.

The motion sensor 21 detects movements of the shaver, in particular vibrations, and the orientation sensor 20 provides an output signal representing the orientation of the shaver. The sensor outputs are provided to a shaver controller 22 (i.e. an example of a care device controller).

The controller unit uses the motion sensor signals (and optionally orientation sensor information) to implement a cleaning program of the shaver. In particular, the motion sensing is used to sense when a cleaning program has been started in the cleaning device 14, without requiring a user input to the shaver and without requiring any electrical communication between the cleaning device and the shaver. The orientation sensing is used to detect when the shaver is in a cleaning orientation (i.e. within a predefined range of angular orientations relative to a default cleaning orientation), e.g. within a predefined range relative to the vertical direction. The cleaning orientation is for example vertical if a PCB which carries the orientation sensor is vertical when the shaver is supported by the cleaning device. However, the cleaning orientation may be offset from the vertical, or more generally the sensed orientation corresponding to the cleaning orientation may be offset from the vertical.

The cleaning device 14 comprises a cleaning unit, for example comprising an ultrasonic vibration generator 30, typically in the form of a piezoelectric ultrasound transducer. The cleaning device also comprises a cleaning device controller 34. A cleaning program is started by the user by actuating the cleaning device. This may involve pressing a start button, or the cleaning program may start automatically the shaver is mounted to the cleaning device.

The cleaning unit induces vibrations to the cleaning device and these are transferred to the shaver by the coupling between the shaver and the cleaning device.

The shaver controller then implements a corresponding cleaning program for the shaver in response to detection of the cleaning device cleaning program from the motion sensor signals.

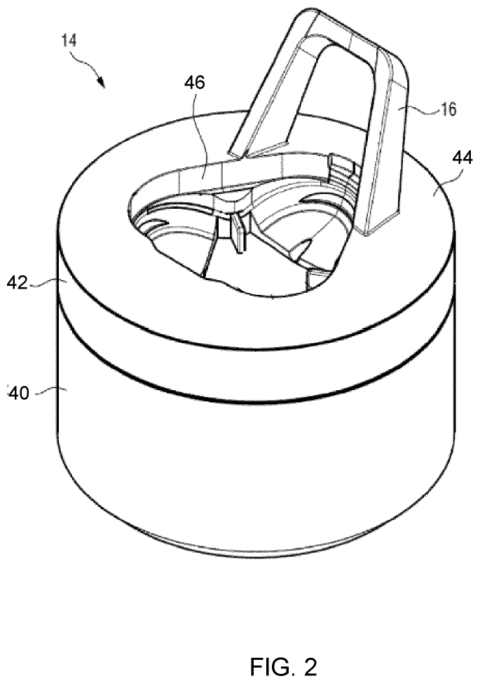

FIG. 2 is an enlarged perspective representation of the cleaning device 14. It comprises a pot-shaped fluid container with a lower housing portion 40 onto which an upper housing portion 42 is placed. The upper housing portion 42 has a top wall 44, wherein a substantially triangular opening is formed that provides access to a receiving space 46 extending into the interior of the housing. The shape of the receiving space 46 corresponds to the shape of a respective shaving unit (e.g. a three headed shaving unit in this example) provided on the shaver 12. When the shaver 12 is placed with its shaving unit within the receiving space 46 as shown in FIG. 1, the main housing of the shaver 12, which is in the shape of a handle, is supported by the rest 16.

The fluid container is attached to the ultrasonic actuator. The cleaning device comprises a power supply to drive the ultrasonic actuator. The shaver is not electronically connected to the cleaning device and is only mechanically connected through a clamp which holds the shaver in position. There is also no mechanical drive system which couples any rotation of the shaver to the cleaning device. Thus, the cleaning unit is mechanically independent of the shaver.

The controller of the shaver runs an algorithm which detects characteristic vibrations, in particular motor rpm patterns of the ultrasonic generator.

The start of the detected vibration is used to actuate the cleaning program of the shaver. Thus, the cleaning program in the cleaning device is leading the overall cleaning process.

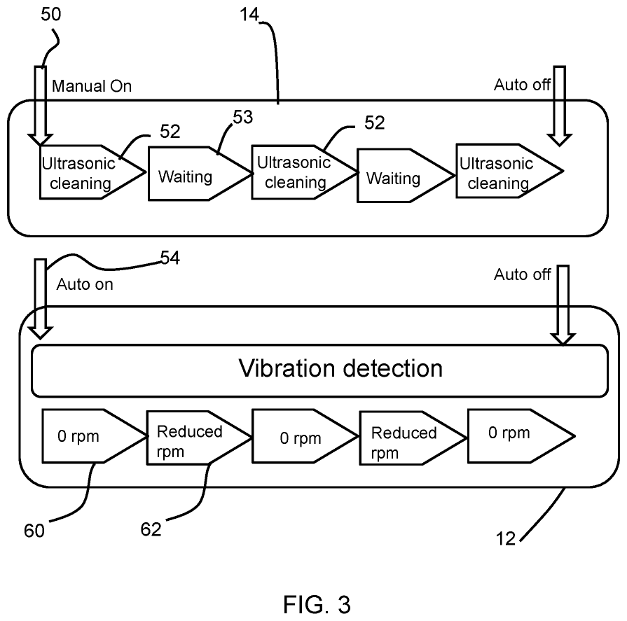

FIG. 3 shows an example of the cleaning program implemented by the cleaning device 14 and by the shaver 12.

As shown, the cleaning program in the cleaning device is started manually by the user as shown by arrow 50, by pressing a start button, or simply by mounting the shaver on the cleaning device. An ultrasonic cleaning phase 52 then starts. This induces motor vibrations which are transferred to the shaver and detected by the motion sensor of the shaver.

In response, the shaver starts a synchronized cleaning program. Thus, the shaver cleaning program is started automatically as shown by arrow 54. During the cleaning phase 52 there is no rotation of the shaver cutters, during phase 60. When the ultrasonic cleaning phase 52 has ended, there is a waiting phase 53 of the cleaning device and the shaver detects this end of vibration. The shaver motor then operates with a reduced rpm compared to its normal operational rpm in phase 62. The purpose is to expose different parts of the shaver cutters to the cleaning process.

The cleaning programs continue with a sequence of cleaning phases 52 of the cleaning device and still phases 60 of the shaver, and waiting phases 53 of the cleaning device and slow rotation phases 62 of the shaver. Thus, the shaver responds to the end of the first cleaning phase 52 by starting to rotate with a reduced rpm (compared to a shaving rpm), but when the next vibration session starts, the appliance responds by stopping the rotation. The low speed will prevent the cleaning medium from splashing too much and avoids washing out of grease in critical components like gears, levers or cutting elements. A slow rotation also ensures all areas of the functional parts are exposed to the fluid. This is especially important for epilating systems for which a stopped position may have some tweezers open and some closed.

The cleaning programs are ended automatically. This will happen if the shaver is lifted off the cleaning device, so that the orientation sensor detects the shaver is not in a cleaning orientation. Alternatively, the cleaning program may end (in both the cleaning device and the shaver) after a predetermined number of ultrasonic cleaning cycles. There may also be a manual off function.

The invention is applicable to many different types of existing personal care devices that already have cleaning stations, not only shavers. It is for example applicable for beauty devices like epilators, and in general for hair removal devices.

Different personal care devices may be designed to fit to the same cleaning device, and may be programmed to respond in different ways to the cleaning cycles of the cleaning device.

The invention has been described with reference to ultrasonic cleaning, for example in the range 20 kHz to 1 MHz. The vibrations may instead be at the high frequency end of the audible spectrum, for example in the range 10 kHz to 20 kHz. However, the concept of the invention may be applied to any cleaning system which generates characteristic vibrations or other motions, such as vibrations generated by a motor of a pump in a pumped cleaning system. As long as the cleaning function of the cleaning device results in a characteristic motion that can be detected by the personal care device, motion sensing may be used to control the cleaning program in the personal care device without needing any driven mechanical coupling or an electrical or optical coupling or communication between the personal care device and the cleaning device.

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a”or “an”does not exclude a plurality.

Functions implemented by a processor may be implemented by a single processor or by multiple separate processing units which may together be considered to constitute a “processor”. Such processing units may in some cases be remote from each other and communicate with each other in a wired or wireless manner.

The mere fact that certain measures are recited in mutually different dependent claims does not indicate that a combination of these measures cannot be used to advantage.

A computer program may be stored/distributed on a suitable medium, such as an optical storage medium or a solid-state medium supplied together with or as part of other hardware, but may also be distributed in other forms, such as via the Internet or other wired or wireless telecommunication systems.

If the term “adapted to” is used in the claims or description, it is noted the term “adapted to” is intended to be equivalent to the term “configured to”. If the term “arrangement” is used in the claims or description, it is noted the term “arrangement” is intended to be equivalent to the term “system”, and vice versa.

Any reference signs in the claims should not be construed as limiting the scope.

1. A personal care system comprising a personal care device and a cleaning device wherein:
the personal care device comprises:
a care device motor
a personal care unit driven by the care device motor;
a motion sensor; and
a care device controller and
the cleaning device comprises:
a supporting structure for supporting the personal care device in a cleaning position for cleaning the personal care unit;
a cleaning unit; and
a cleaning device controller, wherein:
there is no electrical communication and no mechanical drive coupling between the personal care device and the cleaning device,
the cleaning device controller is configured to implement a cleaning device cleaning program in response to a user action; and
the care device controller is configured to implement a corresponding personal care device cleaning program in response to detection of the cleaning device cleaning program from the motion sensor signals.

2. The system of claim 1, wherein the motion sensor comprises an accelerometer.

3. The system of claim 1, wherein the cleaning unit comprises a sound generating unit.

4. The system of claim 3, wherein the cleaning unit comprises an ultrasonic vibration generator wherein the care device controller is configured to detect and recognize ultrasonic vibration generator vibrations.

5. The system of claim 4, wherein the cleaning device cleaning program comprises a sequence of vibration phases and waiting phases.

6. The system of claim 5, wherein the personal care device cleaning program comprises rotations of the personal care unit between the vibration phases, and stationary holding of the personal care unit during the vibration phases

7. The system of claim 1, wherein the personal care system comprises a hair treatment system, the personal care device comprises a hair treatment device and the personal care unit comprises a hair treatment unit.

8. The system of claim 7, wherein:
the hair treatment device comprises a shaver or trimmer and the hair treatment unit comprises a shaver or trimmer head; or
the hair treatment device comprises an epilator and the hair treatment unit comprises an epilator head.

9. A personal care device comprising:
a motor
a personal care unit driven by the motor;
a motion sensor; and
a care device controller,
wherein the care device controller is configured to implement a personal care device cleaning program in response to detection of motion of the personal care device, using the motion sensor, resulting from movements generated by the start of a cleaning program of a remote cleaning device which supports the personal care device in a cleaning position for cleaning the personal care unit, and
wherein the personal care device cleaning program is started based on motion sensor signals with no electrical communication and no mechanical drive coupling between the personal care device and the cleaning device.

10. The device of claim 9, wherein the motion sensor comprises an accelerometer.

11. The device of claim 9, wherein the personal care device cleaning program comprises:
rotations of the personal care unit between vibration phases of the cleaning program of the remote cleaning device; and
stationary holding of the personal care unit during the vibration phases

12. The device of claim 9, wherein:
the personal care device comprises a shaver or trimmer and the personal care unit comprises a shaver or trimmer head; or
the personal care device comprises an epilator and the personal care unit comprises an epilator head.

13. A method of controlling a personal care system comprising a personal care device and a cleaning device, the method comprising:
implementing a cleaning device cleaning program in response to a user action, thereby to drive a cleaning unit of the cleaning device; and
detecting motion of the personal care device resulting from movements generated by the cleaning device cleaning program, using a motion sensor of the personal care device, and in response implementing a corresponding personal care device cleaning program,
such that the personal care device cleaning program is implemented with no electrical communication and no mechanical drive coupling between the personal care device and the cleaning device.

14. A method of controlling a personal care device comprising a motor, a personal care unit driven by the motor and a motion sensor, wherein the method comprises:
detecting motion of the personal care device resulting from movements generated by a cleaning device cleaning program of a remote cleaning device which supports the personal care device in a cleaning position for cleaning the personal care unit, using the motion sensor of the personal care device, and in response implementing a corresponding personal care device cleaning program,
such that the personal care device cleaning program is implemented with no electrical communication and no mechanical drive coupling between the personal care device and the cleaning device.

15. A computer program comprising computer program code means which is adapted, when said program is run on the controller or controllers of a personal care system or personal care device, to implement the method of claim 13.

16. A computer program comprising computer program code means which is adapted, when said program is run on the controller or controllers of a personal care system or personal care device, to implement the method of claim 14.
